(19) United States
(12) Patent Application Publication
(10) Pub. No.: US 2013/0077062 A1
(43) Pub. Date: Mar. 28, 2013

(54) PROJECTOR SYSTEM HAVING INTERCHANGEABLE LIGHT SOURCE MODULES

(71) Applicant: Kenneth K. LI, Castaic, CA (US)

(72) Inventor: Kenneth K. LI, Castaic, CA (US)

(21) Appl. No.: 13/527,003

(22) Filed: Jun. 19, 2012

Related U.S. Application Data
(60) Provisional application No. 61/499,501, filed on Jun. 21, 2011.

(51) Int. Cl. G03B 21/14; G03B 21/28

(52) U.S. Cl. CPC G03B 21/145; G03B 21/28
USPC 353/98; 353/119

(57) ABSTRACT

A projector system has interchangeable light source modules. The projector housing contains an imaging panel and a projection engine and has an inlet for receiving light from an external light source. At least one light source module contains a light source, a light outlet, and an internal focusing system such that substantially all of the light generated by the light system passes out through said outlet. The projector housing and module housing each contain hardware for releasably connecting the two separate housings to one another at a precise relative location so that substantially all of the light generated inside the module housing and exiting the outlet enters through the inlet of said projector housing.

### CROSS-REFERENCE TO RELATED APPLICATIONS

The present application claims priority on U.S. provisional application No. 61/499,501, filed on Jun. 21, 2011.

### BACKGROUND OF THE INVENTION

The applicant of the present invention has proposed a number of systems to improve the brightness of various types of light sources, in which light from a light source which would otherwise be wasted is recycled and used to increase brightness. An example of such a system is disclosed in U.S. Pat. No. 7,631,989, entitled “Dual Paraboloid Reflector and Dual Ellipsoid Reflector Systems With Optimized Magnification.” Such systems may be employed in a number of different type applications, including digital projectors.

FIG. 1 shows schematically, in a greatly simplified form, a projector 10 having a housing 12, a power supply 14, a projection engine 16, and an imaging panel 18. The projector 10, as its light source, includes a reflector assembly 20 comprising a xenon lamp 22 and a three-dimensional reflector 24, typically elliptical in shape. The arc of the lamp 22, which receives power from the power supply 14, is positioned at the focal point FP1 of the reflector 24. The reflector 24 focuses light reflected from the lamp 22 at a second focal point FP2.

A light pipe 26, which in the example is a straight light pipe, but which may be any type, such as tapered, is positioned so that one end is located at the second focal point. The light pipe 26 acts to homogenize the light as it travels through the light pipe toward the outlet end 28, so that the light appears to be uniform at the outlet end 28.

The projector engine 16 may be aligned with the axis 30 of the light pipe 26. Alternatively, the output from the light pipe 26 may be directed toward the projector engine using a mirror 32 and lenses 34. Upon reaching the projector engine 16, the output of the light pipe 26 is imaged onto the imagining panel 18, which may be a DLP™, LCOS, or the like. The imaging panel 18 is controlled digitally, in a known manner, to produce the desired image, which is then output through a focusing lens mechanism 36 onto a screen (not shown).

Digital projectors, for example digital cinema projectors, require using a very bright light, such as a xenon lamp, as the light source. A xenon lamp typically has a lifetime ranging from a few hundred hours to several thousand hours, and thus periodically needs to be replaced. Xenon lamps are under high pressure and care needs to be exercised to ensure safety when removing it from the projector housing. When the replacement assembly is installed, the lamp needs to be aligned either manually or with servo motors and adjusted until maximum coupling efficiency is achieved.

Projector lamps also need to be changed for different types of application. For example, when showing a 3D movie rather than a 2D movie, the applications have different power requirements. Typically, 3 kW lamps are used for 2D projection, whereas 6 kW lamps are required for 3D projections. As a result, the lamp housings may need to be changed on a regular basis, and each change involves time-consuming and potentially hazardous operations.

### SUMMARY OF THE INVENTION

A projector system has interchangeable light source modules. The projector housing contains an imaging panel and a projection engine and has an inlet for receiving light from an external light source. At least one light source module contains a light source, a light outlet, and an internal focusing system such that substantially all of the light generated by the light system passes out through said outlet. The projector housing and module housing each contain hardware for releasably connecting the two separate housings to one another at a precise relative location so that substantially all of the light generated inside the module housing and exiting the outlet enters through the inlet of said projector housing.

### BRIEF DESCRIPTION OF THE DRAWINGS

FIG. 1 is a simplified, schematic drawing of a cinema projector according to the prior art;

FIG. 2 is a schematic drawing of a first embodiment of a projector/modular light source assembly according to the invention;

FIG. 3 is a schematic drawing of a second embodiment of a projector/modular light source assembly according to the invention; and

FIG. 4 is a schematic depiction of a projection system having a projector with multiple, interchangeable modular light source housings.

### DETAILED DESCRIPTION OF THE INVENTION

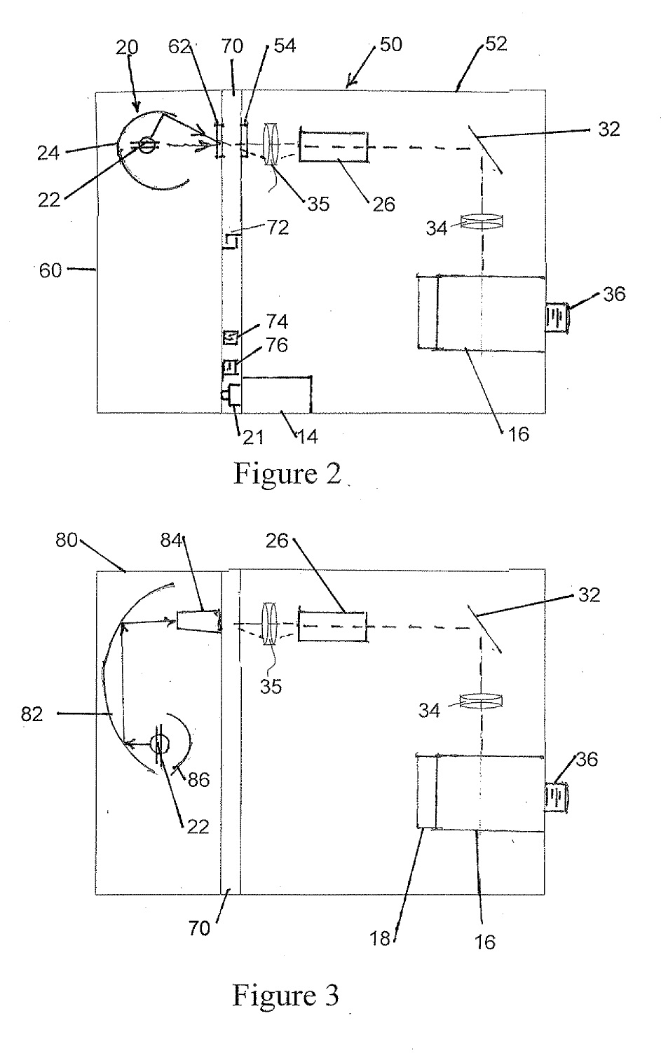

Referring to FIG. 2, a system according to the invention includes a projector 50, a light source module 60, and a connection mechanism 70 for releasably coupling the module 60 to a specified location on the projector housing 52. Preferably, the module 60 and projector housing 52 include a plurality of interlocking elements, shown schematically as 72 which, when engaged, lock the module 60 and housing 52 at a precise location relative to one another. A locking knob 74 may be used to lock the elements 72 in place and unlock the elements 72 from one another when desired. Preferably, various known type quick-connect hardware, such as using rotating locking levers and handles, may be employed for quick module changeovers. Also, if desired the connection mechanism may include an adjustment mechanism operated, e.g., by an adjustment knob or servo motors 76, to move the housing of the module 60 relative to the projector housing 52 to fine tune the relative position and align the module 60 relative to the housing 52.

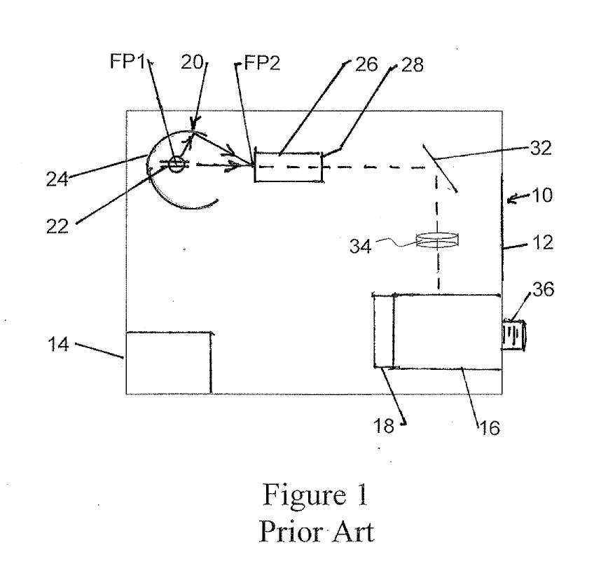

As shown in FIG. 2, the module 60 includes an outlet window 62 which aligns with an inlet window 54 in the projector housing 52 when the members are secured to one another. The example of FIG. 2 uses a reflector assembly 20 comprising a xenon lamp 22 and a three-dimensional reflector 24, similar to that shown in FIG. 1. However, because it may be impractical to locate the input end of the light pipe 26 at the second focal point FP2 of the reflector 24, lenses 35 may be positioned in the path of the light from the lamp 22 and reflector 24 to refocus the light on the input of the light pipe 26. The lens system 35 acts to collimate and refocus the diverging light from the light source module 60. This collimation may be desired with certain types of projector systems where parallel beams are used, such as LCD or LCOS projectors, where the parallel beam is processed with fly-eye lens arrays. Also, in certain cases, fly-eye lens arrays may be used for DLP systems.

The lamp 22 of the module 60 may be powered by the power supply 14 through an electrical connection 21 which is established when the module 60 and housing 52 are joined. For example, the electrical connection 21 may be a socket on one of the housings, and a plug on the other housing.

Referring to FIG. 3, a modular light source 80 includes a xenon lamp 22 with dual paraboloid reflector 82, which causes light from the lamp 22 to be focused, after bouncing twice off the dual paraboloid reflector surface, on the inlet end of a light pipe 84, which may be a straight or tapered light pipe. A dual paraboloid reflector is described in my prior U.S. Pat. No. 7,631,989, which is incorporated herein by reference. The light pipe 84 couples light from the dual paraboloid reflector system into the projection system. The output end of the light pipe 84 is placed at the light input position of the projector. Again, the attachment hardware between the projection housing and light module should be selected to ensure close alignment between the two housings.

A retro-reflector 86 is positioned on the side of the lamp 22 facing away from the dual paraboloid reflector 84, to redirect light from the lamp 22 back towards the dual paraboloid reflector, so that substantially all of the light from the lamp 22 is utilized in the projector.

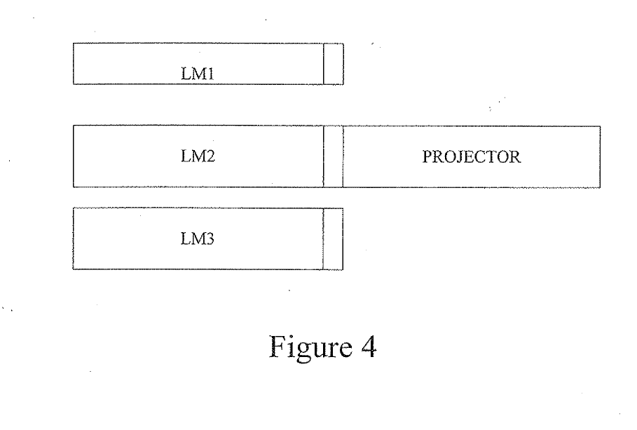

FIG. 4 illustrates how, with the present invention, multiple, interchangeable lamp housings LM1, LM2, LM3, etc. may be available in a single system, so that lamp changes can be done quickly and efficiently with minimum down time. In one embodiment, the lamp housing includes two lamps, e.g. in a dual paraboloid reflector system, having their outputs combined into a single output for coupling to the projector housing. This allows higher output to be projected onto the screen making it more suitable for 3-D applications. Dual lamp systems are also beneficial as using two lamps with half the power will have higher combined power when compared to a single lamp system

Because the light source and projector are housed in separate housings, the light source can be changed simply by removing one lamp housing from the projector and replacing it with another. The lamp housing and projector housing include mounting hardware which aligns the light module and projector housing during the lamp change in a way which provides maximum light coupling. Preferably, the lamp housing and projector are both aligned to a fix reference with alignment hardware such that when the lamp housing is moving into engagement with the projector housing, a pre-determined alignment is ensured for maximum light coupling efficiency.

The foregoing description represents the preferred embodiments of the invention. Various modifications will be apparent to persons skilled in the art. All such modifications and variations are intended to be within the scope of the invention, as set forth in the following claims.

1. A projector system having interchangeable light source modules, said system comprising:
a projector having a housing, said housing containing an imaging panel and a projection engine and having an inlet for receiving light from an external light source;
a projection lens secured to said housing for receiving and projecting an image from said projection engine;
at least one light source module having a module housing containing a light source, a light outlet, and an internal focusing system such that substantially all of the light generated by said light system passes out through said outlet; and
wherein said projector housing and module housing each contain hardware for releasably connecting said housings to one another at a precise relative location so that substantially all of the light generated inside the module housing and exiting said outlet enters through the inlet of said projector housing.

2. The projector system of claim 1, wherein said internal focusing system includes reflective surfaces to focus reflected light from said light source at said outlet.

3. The projector system of claim 1, wherein said module housing includes a light pipe having an input end and an output end located adjacent said outlet, wherein said focusing system includes reflective surfaces to focus reflected light from said light source at said input end of said light pipe.
